(19) United States
(12) Patent Application Publication
(10) Pub. No.: US 2025/0321879 A1
(43) Pub. Date: Oct. 16, 2025

(54) ENHANCED MECHANISM FOR PARTITIONING ADDRESS SPACES

(71) Applicant: QUALCOMM Incorporated, San Diego, CA (US)

(72) Inventors: Jeremy Robin Christopher O'DONOGHUE, Wokingham (GB); Aymeric VIAL, Antibes (FR); Eckhard DELFS, Nürnberg (DE); David HARTLEY, Berlin (DE); Osman KOYUNCU, San Diego, CA (US)

(21) Appl. No.: 19/065,855

(22) Filed: Feb. 27, 2025

Related U.S. Application Data
(60) Provisional application No. 63/634,300, filed on Apr. 15, 2024.
(60) Provisional application No. 63/634,305, filed on Apr. 15, 2024.
(60) Provisional application No. 63/634,318, filed on Apr. 15, 2024.
(60) Provisional application No. 63/634,319, filed on Apr. 15, 2024.

(51) Int. Cl. G06F 12/02

(52) U.S. Cl. CPC G06F 12/023

(57) ABSTRACT

Certain aspects provide a technique for partitioning a memory associated with one or more application processors (AP). For example, a first AP may partition a memory associated with a second AP to create multiple memory regions. The first AP may then allocate different memory regions associated with the second AP to different processing domains associated with the second AP or other APs for different tasks.

### CROSS-REFERENCE TO RELATED APPLICATION

This application claims benefit of and priority to U.S. Provisional Patent Application Nos. 63/634,300, 63/634,305, 63/634,318, and 63/634,319, all filed Apr. 15, 2024, which is hereby incorporated by reference in its entirety.

### BACKGROUND

### Field of the Disclosure

Aspects of the present disclosure relate to techniques for memory management and shared access.

### Description of Related Art

Partitioning operations of a processor in computing systems may be performed to achieve security, isolation, and controlled execution environments. This can be implemented using several mechanisms, primarily for purposes such as security, virtualization, and fault tolerance.

The partitioning may ensure that different processes or applications running on the processor are isolated from one another, which may be vital for security reasons. For example, if one process is compromised (e.g., through a buffer overflow or malware), it should not be able to access or manipulate other processes' data, or underlying hardware.

The partitioning may help contain faults to a specific domain or process, preventing them from spreading across an entire system. For example, if a particular process or virtual machine crashes, the rest of the system remains unaffected. This is especially important for systems where uptime and reliability are critical, such as real-time applications.

The partitioning may ensure that the processor and other resources are allocated effectively and fairly among different tasks or users. For example, in cloud hosting, a hypervisor allocates processor resources to different virtual machines running on a same physical server, ensuring fair performance and preventing one virtual machine from consuming all the resources.

Virtualization involves creating multiple virtual machines on a single physical processor, where each virtual machine operates in its own isolated environment. This partitioning is managed by a layer called a hypervisor. The hypervisor sits between a physical hardware and the virtual machines, ensuring that each virtual machine gets its own allocation of the processor, memory, and storage, while isolating them from each other. Virtual machine are unable to interfere with one another directly, even if they are running on the same physical machine. This creates mutually distrustful environments, as each virtual machine believes it has its own dedicated hardware.

In typical virtualization architectures, the virtual machines are not isolated from the hypervisor. For some security/privacy use cases such as confidential computing it is beneficial to have some virtual machines running on the same processor that are isolated and protected from the hypervisor, creating a further level of security domain called a world in some processor architectures. Virtual machines that are not isolated from the hypervisor are in the “normal” world while isolated virtual machines run in another world.

Memory protection mechanisms enforce boundaries between different parts of a memory associated with the processor, ensuring that one program cannot access or corrupt the memory of another program or the kernel. A memory management unit (MMU) in the processor translates virtual addresses to physical addresses and ensures that programs running in user mode cannot directly access memory allocated to other programs or the kernel. One or more memory isolation techniques help partition execution into independent, mutually distrusting domains.

### SUMMARY

One aspect provides a method by a first processor, including: partitioning a memory associated with at least one second processor to create multiple memory regions; and allocating one or more of the multiple memory regions to at least one of: each of one or more processing domains associated with the at least one second processor or each of one or more third processors.

Other aspects provide: an apparatus operable, configured, or otherwise adapted to perform the aforementioned method as well as those described elsewhere herein; a non-transitory, computer-readable media comprising instructions that, when executed by one or more processors of an apparatus, cause the apparatus to perform the aforementioned method as well as those described elsewhere herein; a computer program product embodied on a computer-readable storage medium comprising code for performing the aforementioned method as well as those described elsewhere herein; and an apparatus comprising means for performing the aforementioned method as well as those described elsewhere herein. By way of example, an apparatus may comprise a processing system, a device with a processing system, or processing systems cooperating over one or more networks.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 illustrates an example computing environment with a memory management unit (MMU) and translation lookaside buffer (TLB) according to various aspects of the present disclosure.

FIG. 2 illustrates example of a system memory management unit (SMMU) according to various aspects of the present disclosure.

FIG. 3 illustrates a system for managing partitioning and allocation of memory regions associated with one or more processors according to various aspects of the present disclosure.

FIGS. 4A and 4B illustrate another system for managing partitioning and allocation of memory regions associated with one or more processors according to various aspects of the present disclosure.

FIG. 5 illustrates a method for managing partitioning and allocation of memory regions associated with one or more processors according to various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Memory management unit (MMU) is a hardware component in a processor responsible for handling memory access and performing address translation from virtual addresses to physical addresses. The MMU plays a critical role in computing systems by enabling efficient memory usage, process isolation, and memory protection. The MMU ensures that a process cannot access memory allocated to another process or the operating system. The MMU facilitates memory sharing between processes while ensuring isolation to prevent interference. The MMU may include a translation lookaside buffer (TLB), page tables, and/or access control logic. The TLB is a specialized cache within the MMU that stores recent address translations. The page tables are data structures maintained by an operating system that map the virtual addresses to the physical addresses. The MMU consults these tables during address translation. The access control logic verifies permissions for memory access (e.g., whether a process can read, write, or execute a specific memory region).

A system MMU (SMMU) is a specialized hardware component used in system on chips (SoCs) and computing platforms. The SMMU is designed to manage memory access and translation specifically for devices like network adapters, and other hardware accelerators that need to access system memory. The SMMU serves a role similar to the MMU, but it operates for peripheral devices instead of the processor. The SMMU enforces access control for devices, ensuring they read or write only to allowed memory regions. The SMMU allows virtual machines to use devices without direct interference from a hypervisor by providing address translation and isolation for those devices. The SMMU enables multiple devices or virtual machines to securely share a same physical hardware. The SMMU provides isolation by ensuring that devices access only the memory areas assigned to them.

Although the SMMU ensures that each device or process accesses only its assigned memory regions and thereby preventing unauthorized memory access or memory corruption. However, adding the SMMU to a system increases hardware design complexity, which can lead to higher costs and longer development cycles.

Aspects of the present disclosure relate to techniques for managing partitioning of a memory or a physical address space associated with a processor and allocation of different partitioned memory regions associated with the processor to different devices using another processor (e.g., at a lower hardware cost). The physical address space is a range of memory addresses that can be directly accessed by the processor.

For example, a first processor may partition a memory associated with a second processor to create multiple memory regions. The first processor may then allocate different memory regions associated with the second processor to other processors or devices for different tasks. The partitioning of the memory refers to dividing a total physical memory into distinct memory regions, each serving specific purposes or being allocated to particular components, processes, or devices. This partitioning is essential for efficient memory utilization, access control, and system functionality.

### Example System-On-a-Chip (SoC)

System-on-a-chip (SoC) devices may include one or more central or application processors, one or more interconnects (or buses), one or more peripheral devices (or upstream devices), and one or more slave devices. The SoC devices may further include a memory management unit (MMU) coupled to a processor and one or more system MMUs (SMMUs) coupled to the one or more peripheral devices.

The MMU is a component of the SoC devices for handling memory-related tasks, such as address translation between virtual and physical memory addresses. The MMU works in conjunction with an operating system of the SoC devices to manage memory allocation and protect memory regions from unauthorized access. The MMU translates virtual memory addresses generated by programs into physical memory addresses, allowing the processor to access appropriate memory locations. Additionally, the MMU enforces memory protection policies by assigning access permissions to the memory regions and ensuring that programs can only access memory areas they are authorized to use. The MMU plays a vital role in optimizing memory usage, enhancing system security, and enabling the efficient execution of programs.

The primary functions of the MMU may include address translation, memory protection, and attribute control. Address translation is the translation of an input address to an output address. Translation information is stored in translation tables that the MMU references to perform address translation. The MMU can store completed translations in a translation cache to avoid accessing the translation tables the next time an input address to the same block of memory is received.

The SMMU is a hardware component designed to manage memory in complex computing systems, such as those found in modern smartphones, tablets, and embedded devices. The SMMU provides address translation services for peripheral device traffic in much the same way that a processor's MMU translates addresses for processor memory accesses. Unlike traditional MMUs, which are integrated into the processor, the SMMUs operate independently and are used in systems with multiple processors and various types of the memory, including a main memory, a graphics memory, and a peripheral memory. The SMMUs provide advanced memory management features, including virtual memory address translation, memory protection, and efficient handling of memory access requests from different processing units. The SMMUs play a crucial role in ensuring efficient memory utilization, enabling hardware acceleration, and enhancing overall system performance in heterogeneous computing environments.

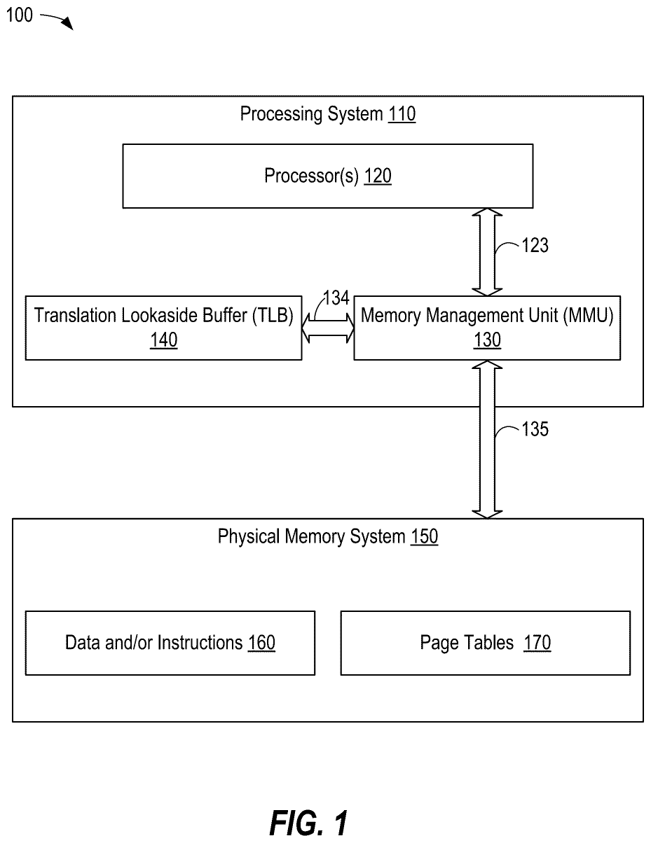

FIG. 1 illustrates an example computing environment 100 for translation lookaside buffer (TLB) compression according to various aspects of the present disclosure. The computing environment 100 includes a processing system 110, which represents a physical computing device or a virtual computing device that runs a on a physical computing device. Processing system 110 includes one or more processors 120, which may represent central processing units (CPUs) and/or other processing devices configured to execute instructions to perform various computing operations.

A processor interconnect 123 may couple the processor(s) 120 to a MMU 130 of the processing system 110. The MMU 130 may perform translation of virtual memory addresses into physical memory addresses. The MMU 130 may be coupled to a TLB 140 of the processing system 110 via a TLB path 134. The TLB 140 may include mappings of virtual memory addresses to physical memory addresses that have been compressed.

The computing environment 100 further includes a physical memory system 150, which may include data and/or instructions 160 and page tables 170. The physical memory system 150 may be, for example a random access memory (RAM). The MMU 130 may be coupled to the physical memory system 150 via a physical memory interconnect 135.

The page tables 170 map each virtual address used by the processing system 110 to a corresponding physical address associated with the physical memory system 150. The physical address may be located in the physical memory system 150, a hard drive (not shown), or some other storage component. When the processing system 110 needs data, the processor(s) 120 may send the virtual address of the requested data to the MMU 130. The MMU 130 may perform the translation in tandem with the TLB 140 and/or physical memory system 150 and then return the corresponding physical address to the processor(s) 120.

To perform the translation, the MMU 130 first checks the TLB 140 to determine if the virtual address of the requested data matches a virtual address associated with one of the TLB 140 entries. If there is a match between the requested virtual address and a virtual address in a particular TLB 140 entry, the processing system checks the TLB 140 entry to determine whether the valid bit is set. If the entry is valid, then the TLB 140 entry includes a valid translation of the virtual address. Accordingly, a corresponding physical address can be returned very quickly to the MMU 130, thereby completing the translation. Using the translated physical address, the processing system 110 can retrieve the requested data.

If the MMU 130 determines that the virtual address of the requested data does not match a virtual address associated with one of the TLB 140 entries (or if a matching TLB 140 entry is marked as invalid), then the MMU 130 walks through the page tables 170 in the physical memory system 150 until a matching virtual address is found.

Each translation may be performed in levels. For example, the MMU 130 may walk through a first page table of the page tables 170 in search of a match. A matching entry found in the first page table may include the first several bits of a physical address and an indication that additional bits may be found in a second page table of the page tables 170. The MMU 130 may then store the first several bits and walk through the second page table in search of a match. As noted above, the matching entry may include the next several bits of the physical address, and the process repeats if the matching entry includes an indication that additional bits may be found in a third page table of the page tables 170. The process may repeat until the matching entry indicates that a last level of translation has been reached. The last level may be, for example, the level that was most-recently reached. Once the last level of translation has been completed, the MMU 130 should have a complete translation of the full physical address.

If there is a match between the requested virtual address and a virtual address in a particular page table entry, the processing system 110 retrieves a physical address from the page table entry. Once found, the physical address is returned to the MMU 130. However, using the page tables 170 to perform the translation may be much slower than using the TLB 140. The TLB 140 is smaller than the physical memory system 150 and less remote than the physical memory system 150. Accordingly, the TLB 140 may be searched more quickly. The TLB 140 typically replicates a subset of the translations located in the page tables 170. The replicated translations are generally associated with virtual addresses that are most important, most frequently-used, and/or most recently-used.

Conventionally, each entry in the TLB 140 may include a single mapping of a virtual address (VA) corresponding to a virtual memory page to a physical address (PA) corresponding to a physical memory page. However, it is generally advantageous to reduce the amount of storage space utilized to store mappings of VAs to PAs in the TLB 140, such as to reduce the size of the TLB 140 and/or to store a larger number of such mappings in the TLB 140 without increasing a size of the TLB 140. Some techniques may involve compressing the VAs and/or PAs in such mappings based on address/page contiguity, including based on bits that are shared between multiple PAs (e.g., corresponding to multiple contiguous physical memory pages), in order to store multiple VA to PA mappings in a single entry of the TLB 140.

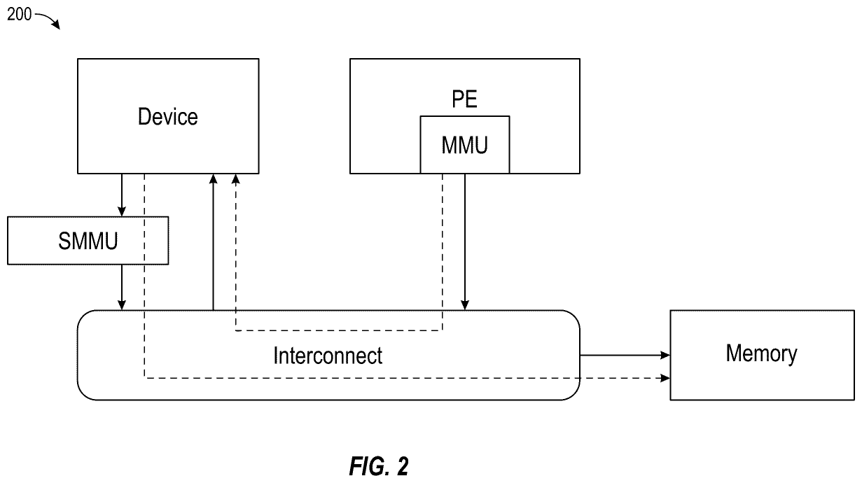

FIG. 2 is an illustration 200 of an example of a SMMU according to various aspects of the present disclosure. The SMMU performs a task that is analogous to that of a MMU (e.g., the MMU 130 of FIG. 1) in a processing element (PE). For example, the SMMU may translate addresses for direct memory access (DMA) requests from a system input/output (I/O) device before the DMA requests are passed into a system interconnect. The SMMU may be active for DMA only. The translation of the DMA addresses may be performed for reasons of isolation or convenience.

The SMMU may only provide translation services for transactions from the device, and not from transactions to the device. For example, traffic (or transactions) in the other direction, that is, from a system or the PE to the device may be managed by other means such as a PE MMU.

In some aspects, in order to associate device traffic with translations and to differentiate different devices behind the SMMU, the DMA requests may have an extra property, alongside address, read/write, permissions, to identify a stream. Different streams may be logically associated with different devices and the SMMU may perform different translations or checks for each stream.

In some aspects, a number of SMMUs may exist within a system. Each SMMU may translate traffic from one device or a set of devices.

The SMMU may support two stages of translation in a similar way to PEs supporting virtualization extensions. Each stage of translation may be independently enabled. An incoming address may be logically translated from a virtual address (VA) to an intermediate physical address (IPA) in stage 1, then the IPA is input to stage 2 which translates the IPA to an output physical address (PA). Stage 1 is intended to be used by a software entity to provide isolation or translation to buffers within an entity. Stage 2 is intended to be available in systems supporting the virtualization extensions and is intended to virtualize device DMA to guest virtual machine (VM) address spaces. When both stage 1 and stage 2 are enabled, the translation configuration is called nested.

The SMMU may have three interfaces that software uses. For example, the SMMU may include memory-based data structures that may be used to map devices to translation tables that are used to translate device addresses. The SMMU may include memory-based circular buffer queues such as a command queue for commands to the SMMU and an event queue for event/fault reports from the SMMU. The SMMU may include a set of registers, some of which are secure-only, for discovery and SMMU-global configuration. The registers indicate base addresses of the structures and queues, provide feature detection and identification registers and a global control register to enable queue processing and translation of traffic.

In some aspects, an incoming transaction may have an address, size, and attributes such as read/write, secure/non-secure, share ability, and cache ability. If more than one device uses the SMMU, the traffic may also have a Stream ID so the sources can be differentiated. The Stream ID corresponds to the device that initiated a transaction.

The SMMU may use a set of data structures in a memory to locate translation data. The registers may hold base addresses of an initial root structure, for example, in a stream table. A stream table entry (STE) may include stage 2 translation table base pointers, and also locates stage 1 configuration structures, which contain translation table base pointers. A context descriptor (CD) represents stage 1 translation, and the STE represents stage 2 translation. In some aspects, there are three address size models to consider in the SMMU such as an input address size from a system, an intermediate address size (IAS), and an output address size (OAS). The SMMU input address size is 64 bits. The IAS reflects a maximum usable IPA of an implementation that is generated by stage 1 and input to stage 2. The OAS reflects a maximum usable PA output from a last stage of translations, and must match a system physical address size.

### Example Partitioning and Allocation of Memory Associated with a Processor

Aspects of the present disclosure provide apparatuses, methods, processing systems, and computer-readable mediums for managing partitioning and allocation of memory regions (e.g., address spaces) associated with one or more processors for different tasks.

One or more mechanisms may be used for partitioning operations of a processor (e.g., a central processing unit) into mutually distrusting domains (e.g., processing domains or worlds). The mutually distrusting domains associated with the processor may refer to separate execution environments or contexts within the processor (or a system) that are isolated from each other due to security, privacy, and/or integrity concerns. The mutually distrusting domains associated with the processor do not trust each other, meaning that they operate under the assumption that other domains may attempt to compromise their security or integrity. The operations of the processor may be partitioned into the mutually distrusting domains to protect confidentiality of resources in the different domains associated with the processor.

The different mechanisms for partitioning the operations of the processor into the mutually distrusting domains may include a confidential virtual machine environment (CoVE) mechanism, a confidential compute architecture (CCA) mechanism, a trust domain extension (TDX) mechanism, etc.

The CoVE is a type of virtualized computing environment designed with a focus on confidentiality and security of data while it is running in virtual machines. The CoVE uses a combination of hardware and software technologies to ensure that data, code, and execution environment are protected from both external and internal threats, even from malicious system administrators or hypervisors.

The CCA is a security model and framework designed to protect data during processing. The CCA leverages hardware-based technologies to ensure that sensitive data remains confidential even when it is being actively used, such as during computation. This architecture is crucial in environments where the risk of data exposure, including access by privileged users or compromised components, needs to be minimized.

The TDX is a security architecture designed to provide strong isolation and security for workloads running in cloud or virtualized environments. The TDX provides an architecture for establishing trusted execution environments (TEEs), or trust domains, within a system. These trust domains are isolated from the rest of the system, ensuring that data inside them remains confidential and protected from malicious software, including the hypervisor, host operating system, and even cloud service providers.

In systems with multiple processors, the processors often operate on a shared memory model. Shared memory is part of a main system random access memory and is accessible to all processors. Each processor can read from and write to this shared memory.

In some distributed computing systems, software or hardware creates an abstraction of a shared memory space across physically separate processors. This allows processors to lend parts of their memory space to others indirectly by making it accessible across the network.

In some systems, a processor may be able to donate resources (e.g., in a physical address space) under its control to an off-processor entity (e.g., another processor) such that operations of the off-processor entity may be kept confidential from a donor processor (i.e., the processor which donates the resources under its control to the off-processor entity). The physical address space refers to an actual range of addresses that a computer's physical memory can access. It represents the hardware's view of memory locations and is determined by the system's memory architecture and the number of address lines on the processor.

In some systems, one or more confidential processing domains or worlds under the processor control may coexist with more than one confidential processing domain or world controlled by more than one off-processor entity.

In some systems, a stage 3 checker (e.g., based on walking page tables) may be used to verify that stage 1 and 2 memory translations from a memory management unit (MMU)/system memory management unit (SMMU) in different processing domains or worlds associated with the processor (e.g., which may be under control of untrusted hypervisors) are valid. The stage 1 translation may translate virtual addresses used by a software (e.g., a process or virtual machine) into intermediate physical addresses. The stage 2 translation may translate the intermediate physical addresses (from stage 1) into the actual physical addresses used by a hardware. In memory system designs, particularly during hardware development or simulation, a stage 3 checker may be a final stage in a series of validation steps (e.g., checking translation correctness after stage 1 and stage 2 translations in a virtualized system).

In some systems, a trusted off-processor entity (e.g., such as a system on a chip (SoC) world controller) that may control programming of stage 3 tables (e.g., preventing the corruption of the stage 3 tables by the processor) may assist. For example, if the trusted off-processor entity may be provided with multiple interfaces, the trusted off-processor entity may operate a memory partitioning protocol allowing co-operation between multiple distrusting domains or actors associated with the trusted off-processor entity.

In some systems, it may be costly in terms of a memory to have all mutually untrusting domains in a system mapped into worlds as this may make required tables unreasonably large, and it might then be desirable to use the stage 3 checker in conjunction with slave-side memory protection units which sub-partition a physical memory allocated to some or all domains. In some cases, placing the memory protection units under control of the SoC world controller may allow for enhanced memory management protocols.

Techniques described herein define a trusted off-processor entity that may manage or control domains separation for a processor. The trusted off-processor entity may act as a relay to manage or control physical address (or memory) partitioning provided by xPUs. An XPU may refer to a graphics processing unit (GPU), a general purpose GPU (GPGPU), a field programmable gate array (FPGA), an accelerated processing unit (APU), an accelerator or other processor. The techniques described herein may allow to sub-partition off processor resources (e.g., such as memory resources) provided by the processor at a lower cost than instantiating additional SMMU components.

One or more hardware devices used to implement the techniques described herein may be managed using a memory management protocol, which may be enhanced with knowledge of SoC sub-domains. One approach may be to enhance or extend a memory protocol to the hardware devices to be SoC sub-domain aware.

The sub-partitioning of processor managed domains or worlds may be performed a low hardware cost. Also, the hardware devices may be easy to integrate with existing systems. These improvements are particularly advantageous in contexts where computing resources are limited and/or where memory management performance is key, such as in the context of mobile devices, machine learning, and/or the like.

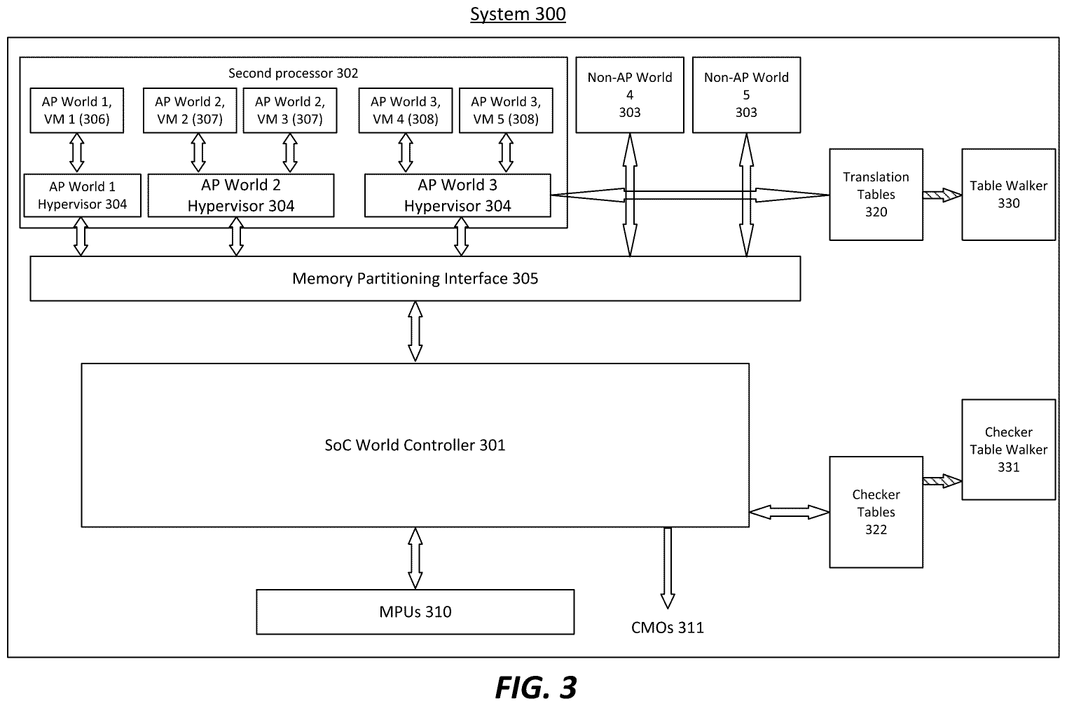

FIG. 3 illustrates a system 300 for managing partitioning and allocation of memory regions associated with one or more processors. The system 300 may include a SoC world controller 301 (e.g., which may be or is associated with a first processor), multiple endpoints (e.g., devices) associated with a second processor 302 (e.g., such as a main processor), and memory protection units (MPUs) 310. The SoC world controller 301 may be associated with the MPUs 310. The SoC world controller 301 may be capable of issuing cache management operations (CMOs) 311 to any of the second, third or subsequent processors. The SoC world controller 301 may be associated with the multiple endpoints 306, 307, 308 and multiple hypervisors 304 associated with the second processor 302 or endpoints associated with third and subsequent processors 303.

The SoC world controller 301 may further be associated with translation tables 320, protection checker tables 322, a translation table walker 330 and/or a checker table walker 331.

The checker tables 322 provide mechanisms for partitioning the address space of the system 300 into multiple regions that are accessible to one or more worlds. The checker tables 322 holds data structures in a memory that are used to manage and enforce memory protection at the granularity of memory granules (e.g., fixed-size blocks of the memory), allowing fine-grained control over memory access. The checker table walker 331 is a hardware or software mechanism responsible for traversing the data structures in the checker tables 322 to resolve access permissions and attributes for memory regions. It is part of a MMU in systems that use the checker tables 322 to enforce physical memory access control.

The translation table walker 330 may be a component of an MMU-based memory management system in modern processors. The translation table walker 330 traverses the translation tables 320 to resolve memory addresses and enforce access permissions for virtual memory and virtualization systems. The translation tables 320 may be configured by a hypervisor 304. As already described for the translation tables 320, the checker tables 322 may also be hierarchical data structures decomposed into two or more levels for efficiency of storage and traversal.

The SoC world controller 301 may be associated with and implement a memory partitioning interface (or a memory partitioning mechanism) 305. The memory partitioning mechanism 305 of the SoC world controller 301 may perform partitioning of a physical address space or a memory associated with the second processor 302 to create mutually untrusting memory regions. The mutually untrusting memory regions on the second processor 302 may be called worlds 306, 307, 308 (e.g., which may be enforced by MMU/SMMU checking tables (e.g., granule protection tables, memory tracking table for supervisor domain isolation)). An MMU/SMMU may support separate translation tables and hypervisors for each world.

The SoC world controller 301 may receive partitioning information for partitioning the memory associated with the second processor 302 into the mutually untrusting memory regions from one or more mechanisms, that may partition the memory associated with the second processor 302 based on a physical address, such as the MPUs 310. The MPU 310 may be a hardware component in a processor designed to enforce access restrictions to different regions of the memory. The MPU 310 may ensure that only authorized processes or programs can access specific areas of memory, enhancing security, stability, and reliability in embedded and real-time systems.

The SoC world controller 301 may receive partitioning information for partitioning the memory associated with the second processor 302 into the mutually untrusting memory regions from one or more mechanisms, that may partition the memory associated with the second processor 302 based on both translation and physical address, such as the MMU.

The SoC world controller 301 may allocate partitioned memory regions associated with the second processor 302 to different endpoints 306, 307, 308 or other processors. For example, an endpoint may be allocated one or more memory regions or worlds associated with the a third or subsequent processor.

In certain aspects, the SoC world controller 301 may perform permanent transfer operations corresponding to the partitioned memory regions associated with the second processor 302. For instance, the memory partitioning mechanism 305 may transfer ownership of a memory region associated with the second processor 302 from one virtual machine endpoint to another virtual machine endpoint within the same world.

In one example, the memory partitioning mechanism 305 may transfer the ownership of the one or more memory regions associated with the second processor 302 allocated for a first processing domain (e.g., application processor (AP) world 2, virtual machine (VM) 2 (307)) associated with the second processor 302 to a second processing domain (e.g., AP world 1, VM 1 (306)) associated with the second processor.

In another example, the memory partitioning mechanism 305 may transfer the ownership of the one or more memory regions associated with the second processor 302 allocated for a donator endpoint (e.g., AP world 2, VM 3 (307)) to a receiver endpoint (e.g., a non-AP world 4 or 5 (303)).

In certain aspects, the SoC world controller 301 may perform lending operations corresponding to the partitioned memory regions associated with the second processor 302. For instance, the memory partitioning mechanism 305 may transfer access rights to a memory region to one or more borrower endpoints without relinquishing ownership but explicitly relinquishing access rights.

In one example, the memory partitioning mechanism 305 may transfer access rights of the one or more memory regions associated with the second processor 302 allocated for the first processing domain associated with the second processor 302 to the second processing domain associated with the second processor 302.

In another example, the memory partitioning mechanism 305 may transfer access rights of the one or more memory regions associated with the second processor 302 allocated for a lender endpoint to a borrower endpoint.

In certain aspects, the SoC world controller 301 may perform share operations corresponding to the partitioned memory regions associated with the second processor 302, to enable access by more than one endpoint. For instance, the memory partitioning mechanism 305 may transfer access rights to a memory region to one or more borrower endpoints while retaining ownership and access rights.

In one example, the memory partitioning mechanism 305 may temporarily share access rights of the one or more memory regions associated with the second processor 302 allocated for the first processing domain associated with the second processor 302 with the second processing domain associated with the second processor 302 for a threshold period.

In another example, the memory partitioning mechanism 305 may temporarily share access rights of the one or more memory regions associated with the second processor 302 allocated for a lender endpoint with a receiver endpoint on a third or subsequent processor for a threshold period.

In certain aspects, the SoC world controller 301 may perform reclaim operations corresponding to the partitioned memory regions associated with the second processor 302. For instance, an owner of a memory region may request that one or more borrower endpoints may relinquish their access rights to a memory region so that the owner can reclaim access.

In one example, the owner of the memory region may request the second processing domain associated with the second processor 302 to relinquish the access rights of the memory region. The owner of the memory region may receive a notification from the second processing domain associated with the second processor 302 that the second processing domain has relinquished the access rights of the memory region.

In another example, the owner of the memory region may request the borrower endpoint on the third or subsequent processor to relinquish the access rights of the memory region. The owner of the memory region may receive a notification from the borrower endpoint that the borrower endpoint has relinquished the access rights of the memory region.

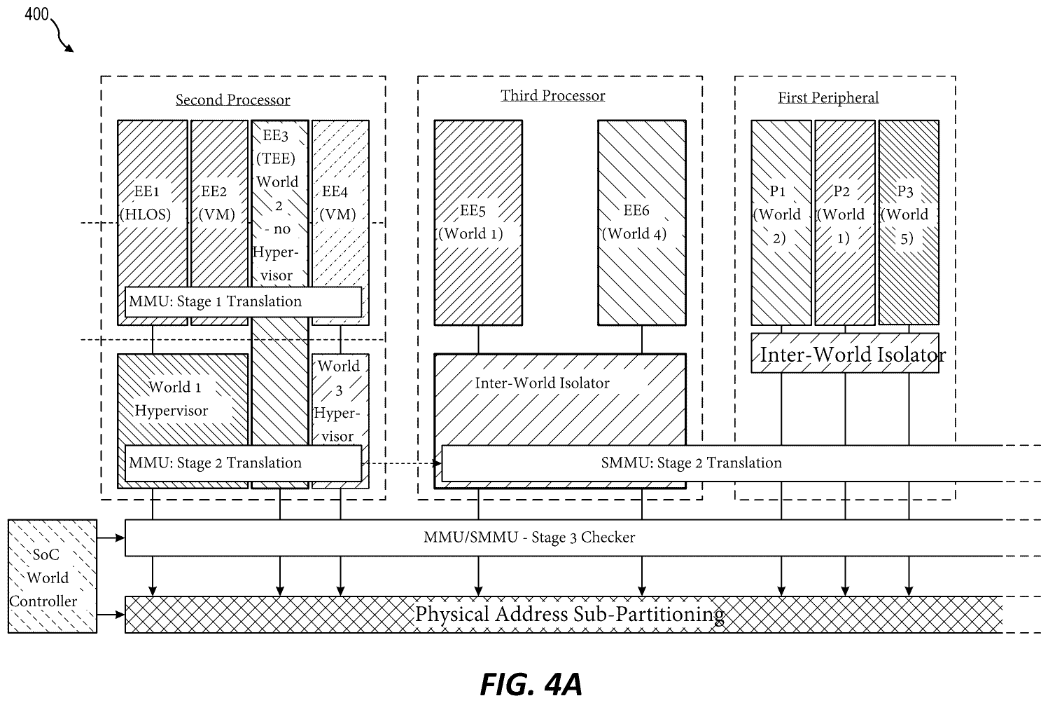

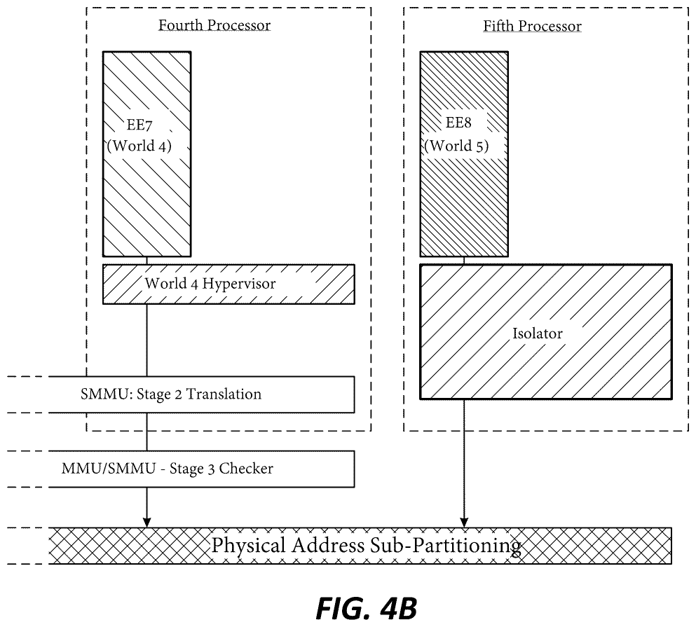

FIGS. 4A and 4B illustrate another system 400 for managing partitioning and allocation of memory regions (or address spaces) associated with one or more processors. The system 400 may include a SoC world controller, a second processor, a third processor, a fourth processor, a fifth processor, a first peripheral device, and a stage 3 checker.

The second processor may include execution environment (EE) 1 (high-level operating system (HLOS)), EE 2 (VM), EE 3 (TEE), and EE 4 (VM). EE 1 is associated with world 1 hypervisor. EE 4 is associated with world 3 hypervisor. The third processor may include EE 5 (world 1) and EE 6 (world 4). EE 5 and EE 6 are associated with an inter-world isolator. The first peripheral device may include P1 (world 2), P2 (world 1), and P3 (world 5). P1, P2, and P3 are associated with an inter-world isolator. The fourth processor may include EE 7 (world 4). EE 7 is associated with world 4 hypervisor. The fifth processor may include EE 8 (world 5).

The second processor may perform MMU stage 1 and 2 memory translations. The third processor, the fourth processor, and the first peripheral device may perform SMMU stage 2 memory translation. The SMMU stage 2 memory translation may be based on the MMU stage 2 memory translation.

The SoC world controller may partition address spaces or memory (e.g., which may be associated with one or more processors). The SoC world controller may allocate one or more partitioned memory regions (e.g., which may be associated with the one or more processors) to other devices such as the second processor, the third processor, the fourth processor, the fifth processor, and/or the first peripheral device. In one example, each of the second processor, the third processor, the fourth processor, the fifth processor, and/or the first peripheral device may be allocated one or more different partitioned memory regions. In another example, one or more worlds associated with the second processor, the third processor, the fourth processor, the fifth processor, and/or the first peripheral device may be allocated the one or more different partitioned memory regions.

### Example Method

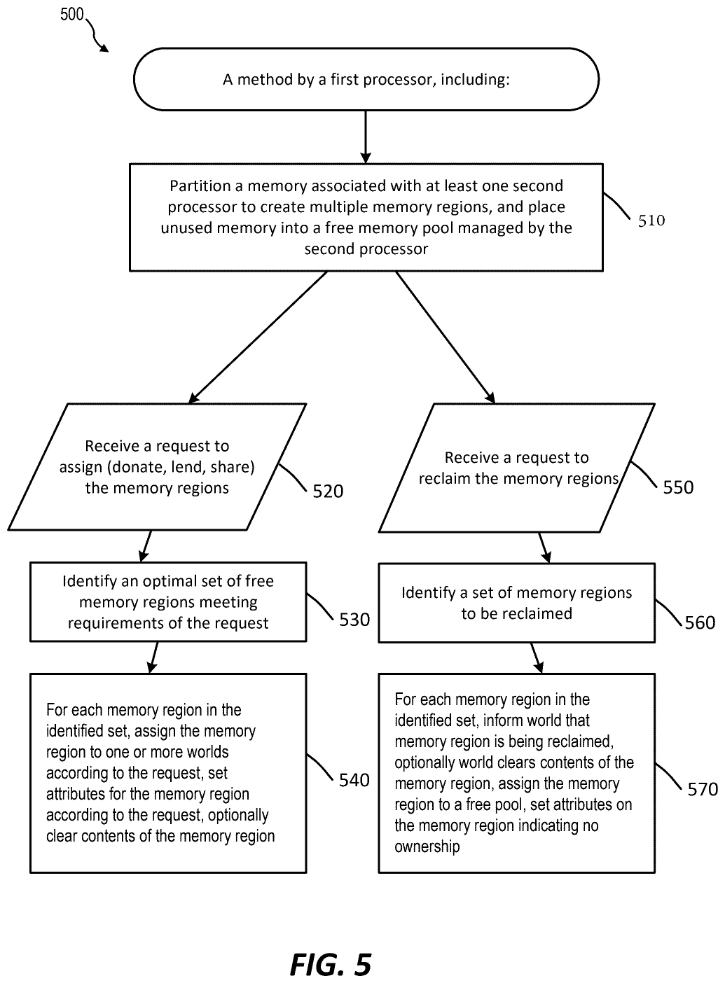

FIG. 5 depicts a method 500 for managing allocation of one or more memory regions associated with one or more processors to one or more other processors. The method 500 is performed by a first processor. The first processor may include one or more processing cores. For example, the first processor may be a trusted off application processor (AP) entity, a system-on-a-chip (SoC) world controller, a root of trust, etc.

Method 500 begins at 510 with partitioning a memory associated with at least one second processor to create multiple memory regions (and marking the memory regions that are not in use). For example, the memory associated with the at least one second processor may be divided into the multiple memory regions such as a first memory region, a second memory region, etc. The second processor may be a main or a primary AP.

At 520, the first processor receives a request to assign (e.g., donate, lend, share) one or more of the multiple memory regions associated with the at least one second processor to one or more processing domains or worlds associated with the at least one second processor and/or associated with each of one or more third processors.

At 530, the first processor identifies a set of free memory regions associated with the at least one second processor meeting requirements of the received request.

At 540, for each memory region in the identified set associated with the at least one second processor, the first processor assigns the memory region to the one or more worlds according to the request. The first processer may set attributes for the assigned memory regions according to the request. The first processor may clear contents of the assigned memory regions.

In some aspects, at 550, the first processor receives a request to reclaim certain memory regions assigned to the one or more worlds.

At 560, the first processor identifies a set of memory regions to be reclaimed based on the request.

At 570, for each memory region in the identified set of memory regions to be reclaimed, the first processor informs the one or more worlds that the assigned memory regions are being reclaimed. The one or more worlds may optionally clear contents of the assigned memory regions. The first processor may assign the reclaimed memory regions to a free pool. The first processor may set attributes on the reclaimed memory regions indicating no ownership.

In certain aspects, the multiple memory regions associated with the at least one second processor may be allocated to different processing domains associated with the at least one second processor. The processing domains associated with the at least one second processor may be mutually distrusting domains or worlds of the main AP.

In certain aspects, the multiple memory regions associated with the at least one second processor may be allocated to different third processors. The third processors may be endpoints such as a GPU, neural processing unit or high assurance processor.

In certain aspects, the first processor, the at least one second processor, and the one or more third processors may have different performance characteristics.

In certain aspects, the first processor, the at least one second processor, and the one or more third processors may have different security characteristics.

In certain aspects, each of the one or more processing domains associated with the at least one second processor may be associated with a supervisory software.

In certain aspects, the method 500 further includes partitioning the memory associated with the at least one second processor based on a memory partitioning mechanism associated with the first processor.

In certain aspects, the method 500 further includes transferring ownership of the one or more of the multiple memory regions allocated for a first processing domain associated with the at least one second processor to a second processing domain associated with the at least one second processor.

In certain aspects, the method 500 further includes transferring ownership of the one or more of the multiple memory regions allocated for a first processing domain associated with the at least one second processor to a receiver third processor.

In certain aspects, the method 500 further includes transferring ownership of the one or more of the multiple memory regions allocated for a donator third processor to a receiver third processor.

In certain aspects, the method 500 further includes transferring access rights of the one or more of the multiple memory regions allocated for a first processing domain associated with the at least one second processor to a second processing domain associated with the at least one second processor.

In certain aspects, the method 500 further includes transferring access rights of the one or more of the multiple memory regions allocated for a first processing domain associated with the at least one second processor to a receiver third processor.

In certain aspects, the method 500 further includes transferring access rights of the one or more of the multiple memory regions allocated for a lender third processor to a borrower third processor.

In certain aspects, the method 500 further includes sharing access rights of the one or more of the multiple memory regions allocated for a first processing domain associated with the at least one second processor with a second processing domain associated with the at least one second processor.

In certain aspects, the method 500 further includes sharing access rights of the one or more of the multiple memory regions allocated for a first processing domain associated with the at least one second processor with a receiver third processor.

In certain aspects, the method 500 further includes sharing access rights of the one or more of the multiple memory regions allocated for a lender third processor with a receiver third processor.

In certain aspects, the method 500 further includes requesting the second processing domain associated with the at least one second processor to relinquish the access rights of the one or more of the multiple memory regions.

In certain aspects, the method 500 further includes receiving a notification from the second processing domain associated with the at least one second processor that the second processing domain has relinquished the access rights of the one or more of the multiple memory regions.

In certain aspects, the method 500 further includes requesting the borrower third processor to relinquish the access rights of the one or more of the multiple memory regions.

In certain aspects, the method 500 further includes receiving a notification from the borrower third processor that the borrower third processor has relinquished the access rights of the one or more of the multiple memory regions.

In certain aspects, the method 500 further includes requesting the receiver third processor to relinquish the access rights of the one or more of the multiple memory regions.

In certain aspects, the method 500 further includes receiving a notification from the receiver third processor that the receiver third processor has relinquished the access rights of the one or more of the multiple memory regions.

In certain aspects, the method 500 further includes receiving partitioning information from one or more devices to partition the memory associated with the at least one second processor based on at least one of a physical address or translation.

In certain aspects, the method 500 further includes receiving partitioning information to partition the memory associated with the at least one second processor based on two or more memory partitioning mechanisms. A first memory partitioning mechanism of the two or more memory partitioning mechanisms may indicate to partition the memory based on a physical address, and a second memory partitioning mechanism of the two or more memory partitioning mechanisms may indicate to partition the memory based on the physical address and translation.

Note that FIG. 5 is just one example of a method, and other methods including fewer, additional, or alternative steps are possible consistent with this disclosure.

### Example Clauses

Implementation examples are described in the following numbered clauses:

Clause 1: A method by a first processor, comprising: partitioning a memory associated with at least one second processor to create multiple memory regions; and allocating one or more of the multiple memory regions to at least one of: each of one or more processing domains associated with the at least one second processor or each of one or more third processors.

Clause 2: The method of clause 1, wherein the first processor, the at least one second processor, and the one or more third processors have at least one of: different performance characteristics or different security characteristics.

Clause 3: The method of any one of clauses 1-2, wherein each of the one or more processing domains is associated with a supervisory component or function.

Clause 4: The method of any one of clauses 1-3, wherein the partitioning comprises partitioning the memory based on a memory partitioning mechanism associated with the first processor.

Clause 5: The method of clause 4, further comprising receiving partitioning information from one or more devices to partition the memory associated with the at least one second processor based on at least one of a physical address or translation.

Clause 6: The method of clause 4, further comprising receiving partitioning information to partition the memory associated with the at least one second processor based on two or more memory partitioning mechanisms, wherein a first memory partitioning mechanism of the two or more memory partitioning mechanisms indicates to partition the memory based on a physical address and a second memory partitioning mechanism of the two or more memory partitioning mechanisms indicates to partition the memory based on the physical address and translation.

Clause 7: The method of any one of clauses 1-6, wherein the allocating comprises transferring ownership of the one or more of the multiple memory regions allocated for a first processing domain associated with the at least one second processor to a second processing domain associated with the at least one second processor.

Clause 8: The method of any one of clauses 1-7, wherein the allocating comprises transferring ownership of the one or more of the multiple memory regions allocated for a first processing domain associated with the at least one second processor to a processing domain associated with a third processor.

Clause 9: The method of any one of clauses 1-8, wherein the allocating comprises transferring ownership of the one or more of the multiple memory regions allocated for a donator third processor to a receiver third processor.

Clause 10: The method of any one of clauses 1-9, wherein the allocating comprises transferring access rights of the one or more of the multiple memory regions allocated for a first processing domain associated with the at least one second processor to a second processing domain associated with the at least one second processor.

Clause 11: The method of clause 10, further comprising: requesting the second processing domain associated with the at least one second processor to relinquish the access rights of the one or more of the multiple memory regions; and receiving a notification from the second processing domain associated with the at least one second processor that the second processing domain has relinquished the access rights of the one or more of the multiple memory regions.

Clause 12: The method of any one of clauses 1-11, wherein the allocating comprises transferring access rights of the one or more of the multiple memory regions allocated for a first processing domain associated with the at least one second processor to a processing domain associated with a third processor.

Clause 13: The method of clause 12, further comprising: requesting the processing domain associated with the third processor to relinquish the access rights of the one or more of the multiple memory regions; and receiving a notification from the processing domain associated with the third processor that the processing domain associated with the third processor has relinquished the access rights of the one or more of the multiple memory regions.

Clause 14: The method of any one of clauses 1-13, wherein: the allocating comprises transferring access rights of the one or more of the multiple memory regions allocated for a lender third processor to a borrower third processor; and requesting the borrower third processor to relinquish the access rights of the one or more of the multiple memory regions; and receiving a notification from the borrower third processor that the borrower third processor has relinquished the access rights of the one or more of the multiple memory regions.

Clause 15: The method of any one of clauses 1-14, wherein: the allocating comprises sharing access rights of the one or more of the multiple memory regions allocated for a first processing domain associated with the at least one second processor with a second processing domain associated with the at least one second processor; requesting the second processing domain associated with the at least one second processor to relinquish the access rights of the one or more of the multiple memory regions; and receiving a notification from the second processing domain associated with the at least one second processor that the second processing domain has relinquished the access rights of the one or more of the multiple memory regions.

Clause 16: The method of any one of clauses 1-15, wherein: the allocating comprises sharing access rights of the one or more of the multiple memory regions allocated for a first processing domain associated with the at least one second processor with a second processing domain associated with a third processor; requesting the second processing domain associated with the third processor to relinquish the access rights of the one or more of the multiple memory regions; and receiving a notification from the second processing domain associated with the third processor that the second processing domain has relinquished the access rights of the one or more of the multiple memory regions.

Clause 17: The method of any one of clauses 1-16, wherein the allocating comprises sharing access rights of the one or more of the multiple memory regions allocated for a lender third processor with a receiver third processor.

Clause 18: The method of clause 17, further comprising: requesting the receiver third processor to relinquish the access rights of the one or more of the multiple memory regions; and receiving a notification from the receiver third processor that the receiver third processor has relinquished the access rights of the one or more of the multiple memory regions.

Clause 19: An apparatus, comprising: at least one memory comprising instructions; and one or more processors configured, individually or in any combination, to execute the instructions and cause the apparatus to perform a method in accordance with any one of Clauses 1-18.

Clause 20: An apparatus, comprising means for performing a method in accordance with any one of Clauses 1-18.

Clause 21: A non-transitory computer-readable medium comprising executable instructions that, when executed by one or more processors of an apparatus, cause the apparatus to perform a method in accordance with any one of Clauses 1-18.

Clause 22: A computer program product embodied on a computer-readable storage medium comprising code for performing a method in accordance with any one of Clauses 1-18.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method by a first processor, comprising:
partitioning a memory associated with at least one second processor to create multiple memory regions; and
allocating one or more of the multiple memory regions to at least one of: each of one or more processing domains associated with the at least one second processor or each of one or more third processors.

2. The method of claim 1, wherein the first processor, the at least one second processor, and the one or more third processors have at least one of: different performance characteristics or different security characteristics.

3. The method of claim 1, wherein each of the one or more processing domains is associated with a supervisory component or function.

4. The method of claim 1, wherein the partitioning comprises partitioning the memory based on a memory partitioning mechanism associated with the first processor.

5. The method of claim 4, further comprising receiving partitioning information from one or more devices to partition the memory associated with the at least one second processor based on at least one of a physical address or translation.

6. The method of claim 4, further comprising receiving partitioning information to partition the memory associated with the at least one second processor based on two or more memory partitioning mechanisms, wherein a first memory partitioning mechanism of the two or more memory partitioning mechanisms indicates to partition the memory based on a physical address and a second memory partitioning mechanism of the two or more memory partitioning mechanisms indicates to partition the memory based on the physical address and translation.

7. The method of claim 1, wherein the allocating comprises transferring ownership of the one or more of the multiple memory regions allocated for a first processing domain associated with the at least one second processor to a second processing domain associated with the at least one second processor.

8. The method of claim 1, wherein the allocating comprises transferring ownership of the one or more of the multiple memory regions allocated for a first processing domain associated with the at least one second processor to a processing domain associated with a third processor.

9. The method of claim 1, wherein the allocating comprises transferring ownership of the one or more of the multiple memory regions allocated for a donator third processor to a receiver third processor.

10. The method of claim 1, wherein the allocating comprises transferring access rights of the one or more of the multiple memory regions allocated for a first processing domain associated with the at least one second processor to a second processing domain associated with the at least one second processor.

11. The method of claim 10, further comprising:
requesting the second processing domain associated with the at least one second processor to relinquish the access rights of the one or more of the multiple memory regions; and
receiving a notification from the second processing domain associated with the at least one second processor that the second processing domain has relinquished the access rights of the one or more of the multiple memory regions.

12. The method of claim 1, wherein the allocating comprises transferring access rights of the one or more of the multiple memory regions allocated for a first processing domain associated with the at least one second processor to a processing domain associated with a third processor.

13. The method of claim 12, further comprising:
requesting the processing domain associated with the third processor to relinquish the access rights of the one or more of the multiple memory regions; and
receiving a notification from the processing domain associated with the third processor that the processing domain associated with the third processor has relinquished the access rights of the one or more of the multiple memory regions.

14. The method of claim 1, wherein:
the allocating comprises transferring access rights of the one or more of the multiple memory regions allocated for a lender third processor to a borrower third processor;
requesting the borrower third processor to relinquish the access rights of the one or more of the multiple memory regions; and
receiving a notification from the borrower third processor that the borrower third processor has relinquished the access rights of the one or more of the multiple memory regions.

15. The method of claim 1, wherein:
the allocating comprises sharing access rights of the one or more of the multiple memory regions allocated for a first processing domain associated with the at least one second processor with a second processing domain associated with the at least one second processor;
requesting the second processing domain associated with the at least one second processor to relinquish the access rights of the one or more of the multiple memory regions; and
receiving a notification from the second processing domain associated with the at least one second processor that the second processing domain has relinquished the access rights of the one or more of the multiple memory regions.

16. The method of claim 1, wherein:
the allocating comprises sharing access rights of the one or more of the multiple memory regions allocated for a first processing domain associated with the at least one second processor with a second processing domain associated with a third processor;
requesting the second processing domain associated with the third processor to relinquish the access rights of the one or more of the multiple memory regions; and
receiving a notification from the second processing domain associated with the third processor that the second processing domain has relinquished the access rights of the one or more of the multiple memory regions.

17. The method of claim 1, wherein the allocating comprises sharing access rights of the one or more of the multiple memory regions allocated for a lender third processor with a receiver third processor.

18. The method of claim 17, further comprising:
requesting the receiver third processor to relinquish the access rights of the one or more of the multiple memory regions; and
receiving a notification from the receiver third processor that the receiver third processor has relinquished the access rights of the one or more of the multiple memory regions.

19. An apparatus, comprising:
a memory comprising instructions; and
one or more first processors configured, individually or in any combination, to execute the instructions and cause the apparatus to:
partition a memory associated with at least one second processor to create multiple memory regions; and
allocate one or more of the multiple memory regions to at least one of: each of one or more processing domains associated with the at least one second processor or each of one or more third processors.

20. A non-transitory computer-readable medium comprising instructions that, when executed by one or more first processors, cause the or more first processors to perform a method, comprising:
partitioning a memory associated with at least one second processor to create multiple memory regions; and
allocating one or more of the multiple memory regions to at least one of: each of one or more processing domains associated with the at least one second processor or each of one or more third processors.
